(19) United States
(12) Patent Application Publication
(10) Pub. No.: US 2013/0243374 A1
(43) Pub. Date: Sep. 19, 2013

(54) OPTICAL BRANCHING ELEMENT, OPTICAL WAVEGUIDE DEVICE USING OPTICAL BRANCHING ELEMENT, AND METHOD OF MANUFACTURING OPTICAL BRANCHING ELEMENT, METHOD OF MANUFACTURING OPTICAL WAVEGUIDE DEVICE

(71) Applicant: Shinya Watanabe, Tokyo (JP)

(72) Inventor: Shinya Watanabe, Tokyo (JP)

(73) Assignee: NEC Corporation, Tokyo (JP)

(21) Appl. No.: 13/988,516

(22) PCT Filed: Nov. 30, 2011
(86) PCT No.: PCT/JP2011/078227

§ 371 Date: May 21, 2013

(51) Int. Cl. G02B 6/28; G02B 6/125

(52) U.S. Cl. CPC G02B 6/2804; G02B 6/125
USPC 385/24; 385/43; 156/60

(57) ABSTRACT

An optical branching element includes: a first waveguide section which has a shape wherein the core width is reduced without variation from a first end section to a second end section; a fourth waveguide section which has a shape wherein the core width is increased without variation from a third end section to a fourth end section respectively connected to the second and a third waveguide sections; and a fifth waveguide section which connects the second end section and the third end section and has a core width of any value from 0.8 μm to 2.7 μm. The relative refractive index of the cores and a clad of the first through fifth waveguide section is at least 1.3% with respect to light in a C band wavelength domain.

### TECHNICAL FIELD

The present invention relates to an optical branching element and an optical waveguide device using an optical branching element, and specifically relates to an optical branching element of Y branch structured-type, an optical waveguide device using the optical branching element thereof, and a manufacturing method of the optical branching element thereof and a manufacturing method of the optical waveguide device.

### BACKGROUND ART

Various optical waveguide devices, which are connected with various optical elements by an optical waveguide and are integrated, are put in practical use with progress of optical waveguide technology in recent years. For composing an optical integrated circuit, an optical branching element is one of important elements in particular in the optical elements used for such optical waveguide device.

Generally, as an optical branching element, for example, a Y branch structured-type optical branching element, a multimode interferometer type optical branching element, a directional coupler or a Mach-Zehnder interferometer type optical branching element is used. These can be produced by applying a film-forming technology and a fine processing technology of a semiconductor manufacturing process.

In case of the directional coupler, the Mach-Zehnder interferometer type optical branching element or the multimode interferometer type optical branching element, optical branch ratio may change sensitively by manufacturing disturbance, such as refractive index variation and a patterning error. The optical branch ratio of the directional coupler, the Mach-Zehnder interferometer type optical branching element or the multimode interferometer type optical branching element varies depending on wavelengths theoretically. Therefore, a used wavelength band must be restricted. On the other hand, the Y branch structured-type optical branching element has a symmetrical structure that dichotomizes an input light from one waveguide and outputs the dichotomized input light. Therefore, the Y branch structured-type optical branching element is usually applied as the most basic optical branching element because if the Y branch structured-type optical branching element is designed appropriately, there is no wavelength dependency of the optical branch ratio and also the Y branch structured-type optical branching element is relatively robust over manufacturing disturbance.

By the way, although it is desirable to make the curvature radius of a curve waveguide portion in an optical waveguide of which an optical integrated circuit is composed as small as possible for device miniaturization, it is necessary to design the curve waveguide portion in an optical waveguide in a certain curvature radius or more in order to suppress occurrence of loss by leak of light. The design value of such minimum radius of curvature is determined by relative refractive index difference between the core of the optical waveguide and the clad of the optical waveguide (hereinafter, referred to as relative refractive index difference) and the size of the core.

Even if the optical waveguide has the same relative refractive index difference, the light confinement effect becomes larger as the optical waveguide transmits much more modes. That is, light which transmits an optical waveguide generally propagates in the state that an electric field leaks to some extent from the optical waveguide. And an ingredient radiated to outside in the curve waveguide can be reduced as the amount of this leakage becomes less. Because this leakage is smaller in a multimode waveguide which transmits many modes than that in a single mode waveguide, and a light is confined strongly in the waveguide and propagates, the arised loss is restrained even in a small bend radius thereof.

On the other hand, in case of a single mode optical waveguide, the higher mode excited in the optical waveguide cannot exist steadily by the leakage to the outside of the optical waveguide, but can propagate only limited distance until the higher mode dissolves. However, by constituting its propagating distance so that a certain amount of the length may be kept on characteristics, even a single mode optical waveguide has the effect to make the bend radius thereof small, suppressing a loss to some extent.

By making an optical integrated circuit by such optical waveguide, it become possible to pull an optical waveguide around by the smaller curvature radius without changing relative refractive index difference, and make the chip size small as a result.

However, when an optical waveguide device including a Y branch-type optical branching element is composed by using such optical waveguide, the following problem occurs.

In the optical waveguide which propagates a plurality of modes, because each mode propagates combining with each other, the center of the electric field distribution of the propagating light is not thoroughly in accord with the center of the wave guide, and it progresses meandering a little.

This meandering state changes by the wavelength of the propagated light, and changes complicatedly by each length of the straight section and the curved part of an optical waveguide or the number of the inflection point. Thus, when the light which propagates meandering in the waveguide enters a Y branch-type optical branching element, because the light continues to meander in the Y branch-type optical branching element, symmetry of branching will be lost.

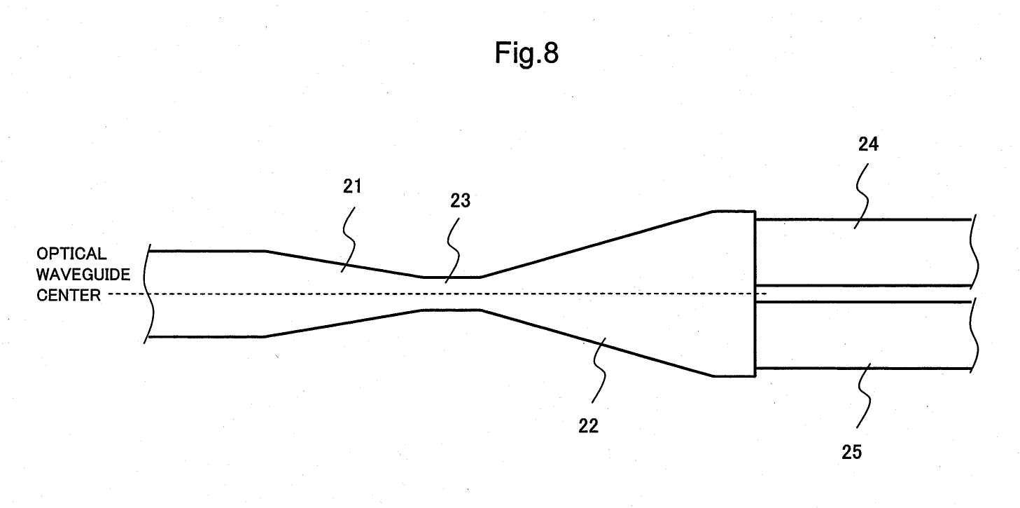

A technology for solving such problem is disclosed in Japanese Patent Application Laid-Open No. 1996-292340 (hereinafter, referred to as patent document 1) or Japanese Patent Application Laid-Open No. 2006-011417 (hereinafter, referred to as patent document 2), for example. As shown in FIG. 8, the technology disclosed in patent documents 1 and 2 is the structure that two tapered portions 21 and 22 are provided in a core of a waveguide portion connected with a Y branch-type optical branching element, and the core width of a slender part 23 between the tapered portion 21 and 22 is narrowed. The width of the slender part 23 is set to 6.0 μm to 6.5 μm in patent document 1, and 3.5 μm in patent document 2. According to this structure, the light which propagates shifting from the center of an optical waveguide by meandering radiates higher mode in range from the tapered portion 21 to the slender part 23, and a light intensity peak is narrowed down to the center of the waveguide. Thereby, because the meandering of the propagating light dissolves and the electric field distribution is branched to two output waveguides 24 and 25 via the tapered portion 22 from the state that the center of the electric field distribution was in accordance with the center of the waveguide, occurrence of deviation of the light branching ratio can be prevented effectively.

### CITATION LIST

### Patent Document

[Patent document 1] Japanese Patent Application Laid-Open No. 1996-292340

[Patent document 2] Japanese Patent Application Laid-Open No. 2006-011417

### DISCLOSURE OF INVENTION

### Problem to be Solved by the Invention

The technology described in patent documents 1 and 2 mentioned above can keep the light branching ratio of the Y-branch type light branching element uniformly in the general light branching device to the extent that does not become a problem, even when the light to propagate meandering in the waveguide enters.

However, in the case of the device which treats phase information in addition to light intensity, in the technology described in patent documents 1 and 2, even if the light intensity peak of the light which propagates meandering in the optical guide circuit is narrowed down to the center of the waveguide, it is very difficult to branch with suppressing a phase shift.

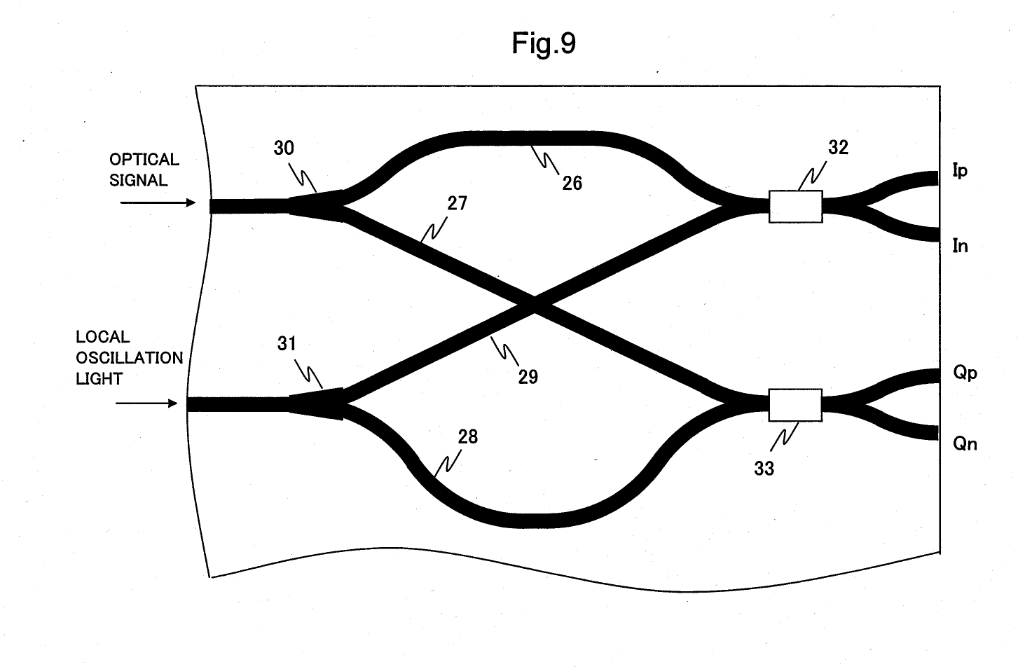

For example, a digital coherent receiver by the polarized orthogonal multiple multi value digital signal modulation method for ultra-high-speed communication may include an optical waveguide device. Such a digital coherent receiver needs an interferometer as shown in FIG. 9 which bears the 90-degree optical hybrid function which extracts phase information from a polarization-demultiplexed light signal. In the interferometer shown in FIG. 9, the optical waveguide arms 26 and 27 are equivalent in an optical path length, and, on the other hand, the optical path length of an optical waveguide arm 28 is made π/2 longer than an optical waveguide arm 29 by phase angle of the propagated light. And an optical signal branched in an optical branching element 30 is input to couplers 32 and 33 by the same phase, respectively. On the other hand, local oscillation light branched in an optical branching element 31 is input to the couplers 32 and 33 by 90-degree phase difference each other. It is said that this phase difference generally has to be within 90±5 degrees in a using wavelength band.

In this interferometer, when a Y branch structured-type optical branching element is employed for the optical branching elements 30 and 31, it is possible to suppress meandering by the technology disclosed in patent documents 1 and 2 to light to propagate meandering through the waveguide, and light can he branched with enough uniformity of strength. However, the great difference is generated between the respective phases of the branched light even if peak strength of the propagating light just before the branch is shifted from the center of the waveguide a little. Accordingly, the technology disclosed in patent documents 1 and 2 can branch uniformly on enough level of light intensity, but it is difficult to control generation of the phase shift of the branched light, and the phase shift causes the restrictions on the device design and a fall of the manufacturing yield.

An object of the present invention is to solve the problem mentioned above, and to provide an optical branching element, an optical waveguide device using the same, and manufacturing methods thereof capable of appropriately suppressing generation of a phase difference to branch light even if the light is incident and shifted from the center of the waveguide.

### Solution to Problem

An optical branching element of the present invention includes: a first waveguide section which has a shape that a core width thereof is reduced without variation from a first end section to a second end section; a fourth waveguide section which has a shape that a core width thereof is increased without variation from a third end section to a fourth end section respectively connected to a second and a third waveguide sections; and a fifth waveguide section which connects the second end section and the third end section and has a core width of a value from 0.8 μm to 2.7 μm, wherein the relative refractive index difference of the cores and the clad of the first through fifth waveguide section is at least 1.3% with respect to light in a C band wavelength domain.

And a manufacturing method of an optical branching element of the present invention includes: a step of forming a first cladding layer on a substrate; a step of laminating a core layer on the first cladding layer; a step of patterning the core layer and forming a core; and a step of covering the core by a second cladding layer that has refractive index identical with the first cladding, wherein the relative refractive index difference of the core and the first cladding and the second cladding is at least 1.3% with respect to light in a C band wavelength domain, and in patterning the core layer, a waveguide section which has a shape that a core width thereof is reduced without variation from a first end section to a second end section, a fifth waveguide section which has a shape that a core width thereof is reduced without variation from a third end section to a fourth end section which connects a second waveguide section and a third waveguide section respectively, and a fifth wave guide section which connects the second end section and the third end section and has core width of any value from 0.8 μm to 2.7 μm are formed.

### Advantageous Effects of Invention

According to the present invention, an optical branching element, an optical waveguide device using the same and manufacturing methods thereof capable of appropriately suppressing generation of a phase difference to branch even if incident light is shifted from the center of the waveguide can be provided.

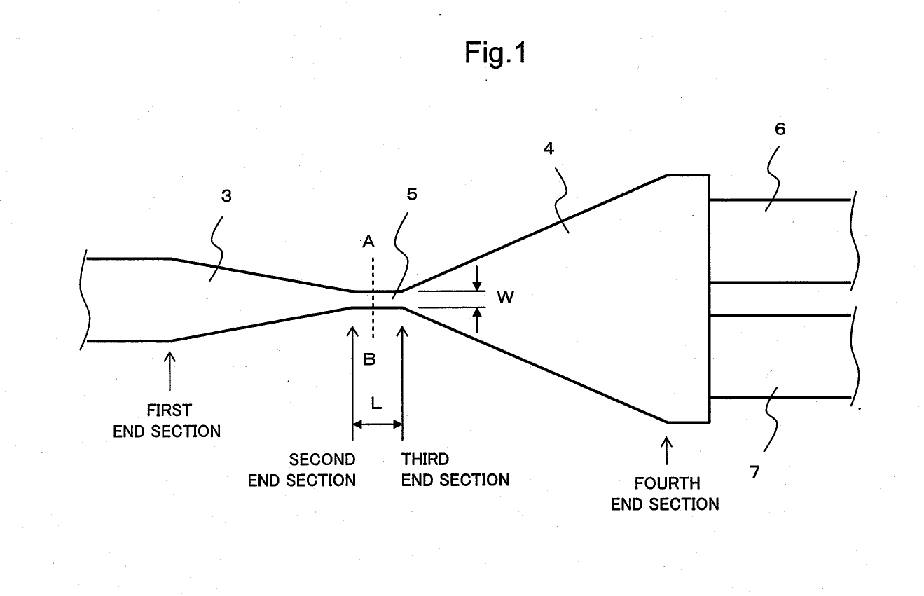

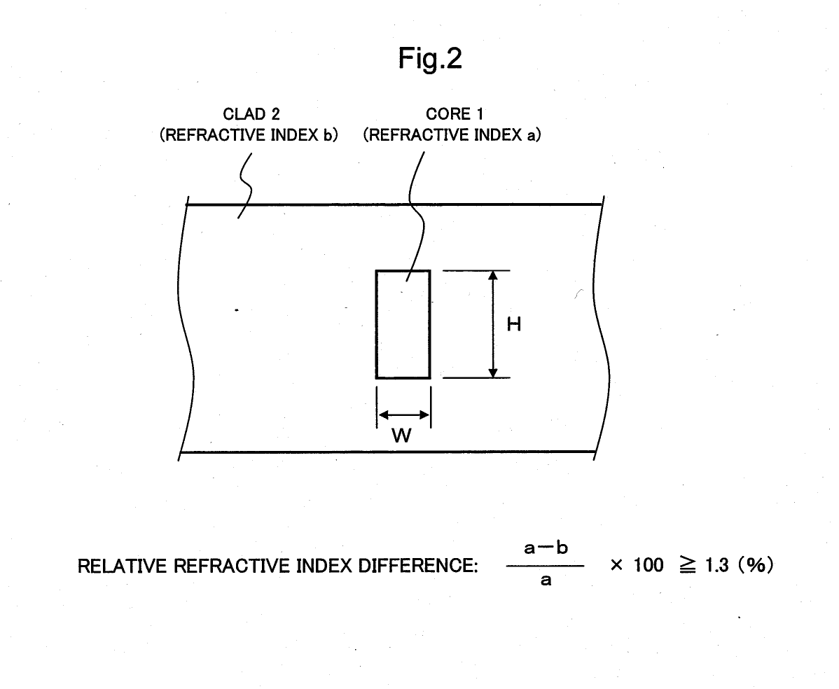

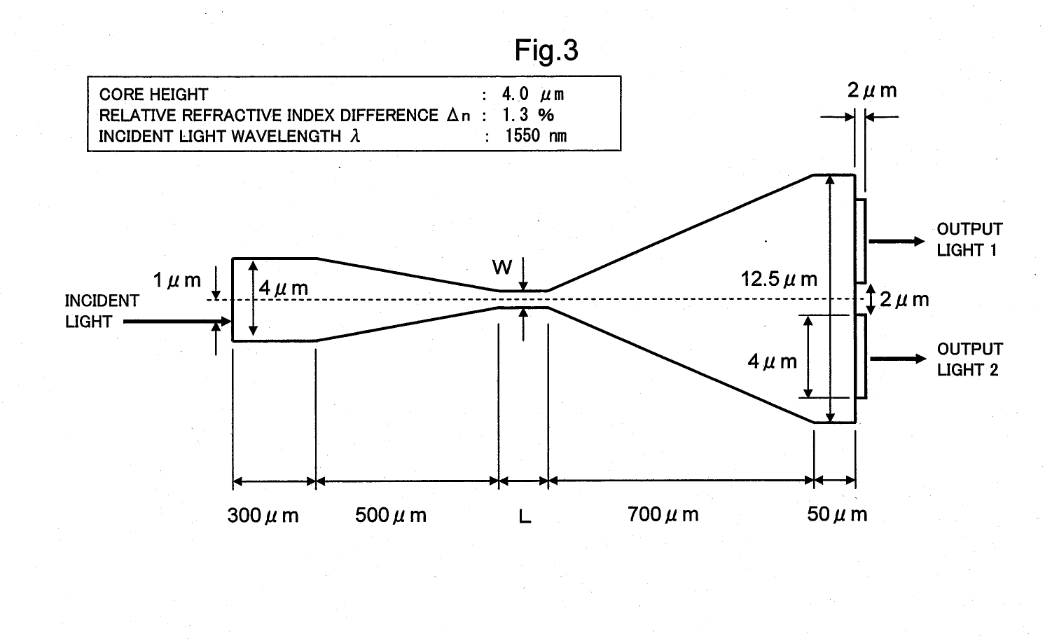

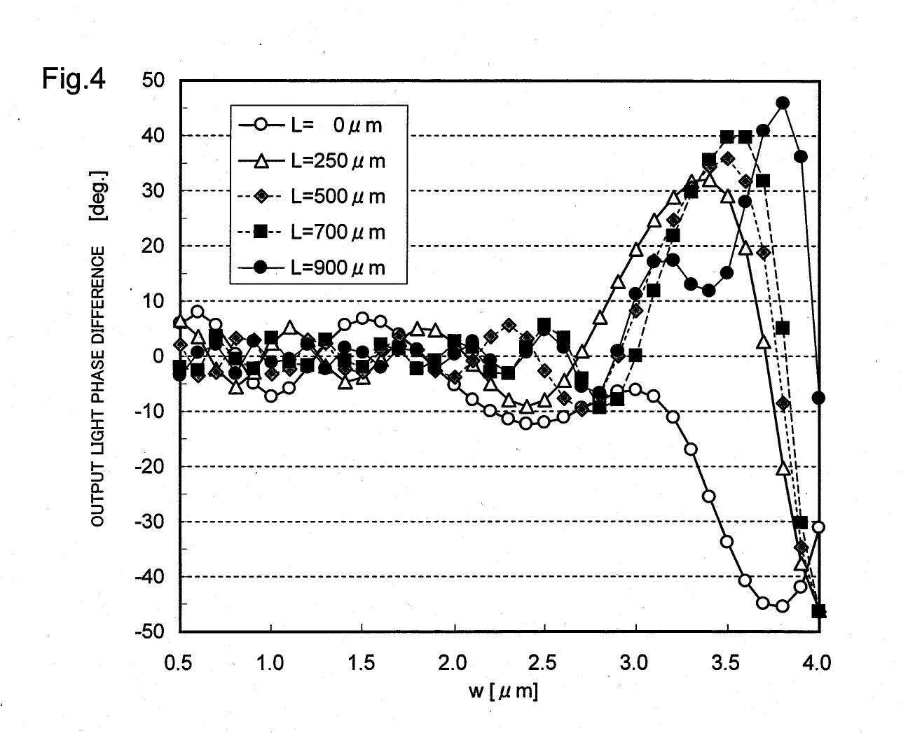

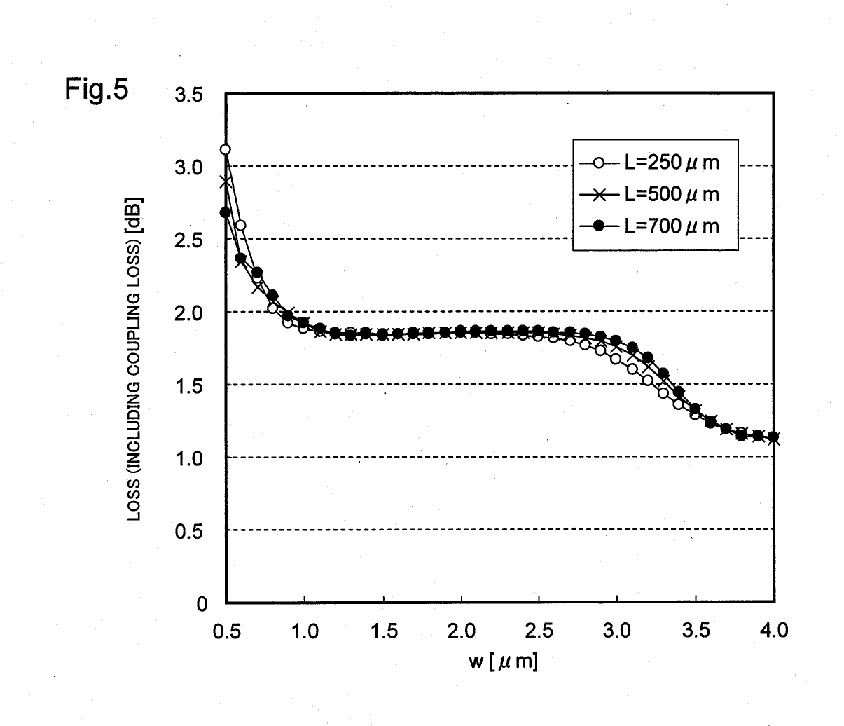

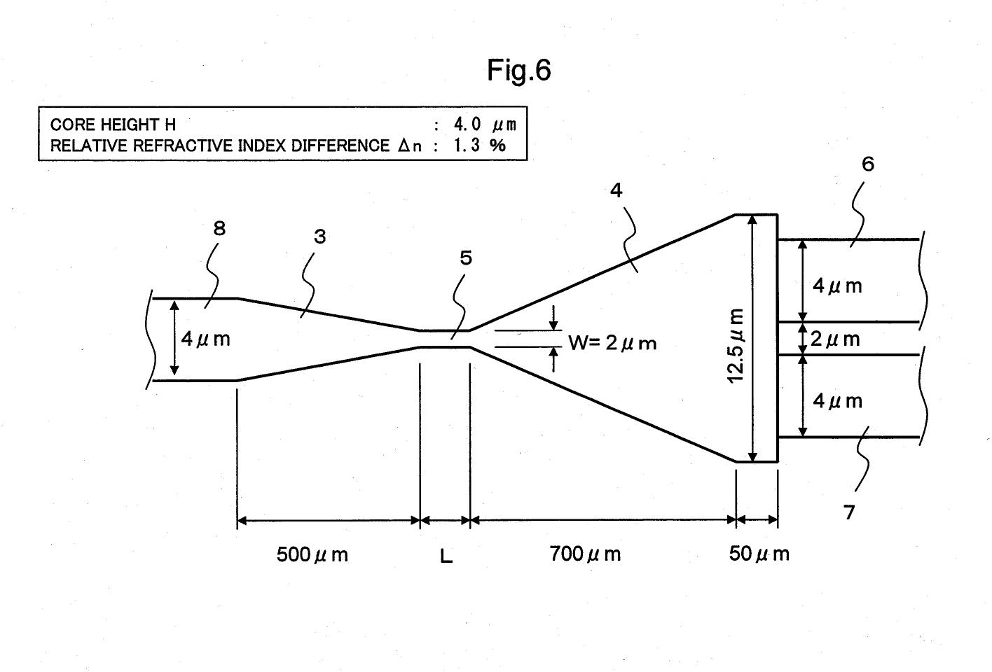

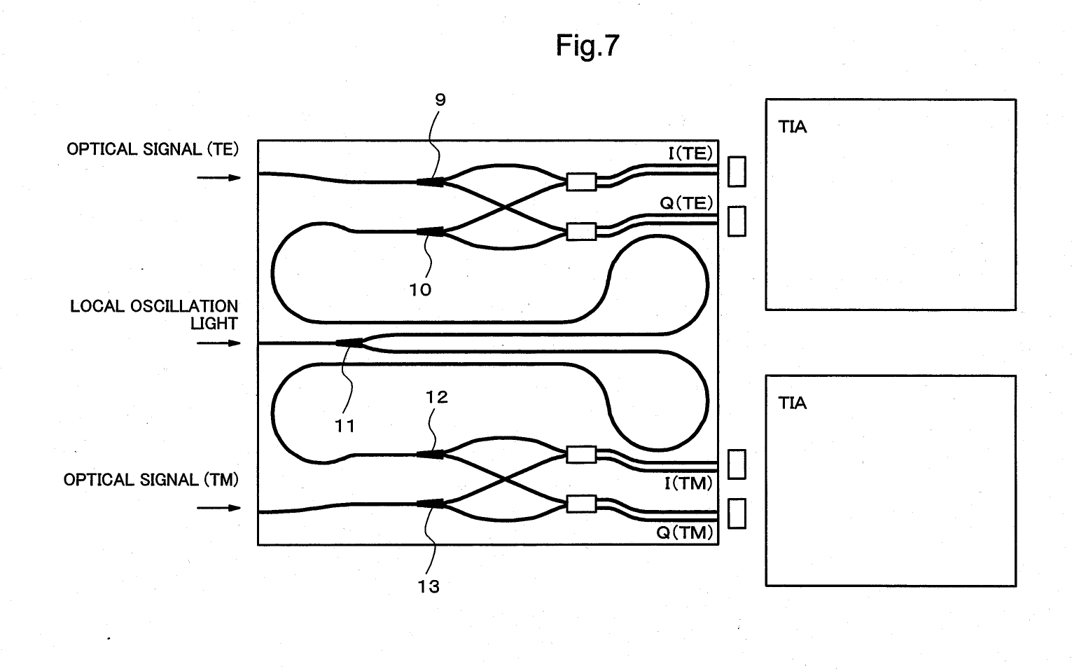

### BRIEF DESCRIPTION OF THE DRAWINGS

[FIG. 1] A top view showing a structure of an optical waveguide core of an optical branching element of a first exemplary embodiment of the present invention

[FIG. 2] A sectional view showing an optical waveguide structure of the optical branching element of the first exemplary embodiment of the present invention

[FIG. 3] A top view showing a structure of an optical branching element model used for characteristics calculation of the present invention

[FIG. 4] A graph showing a change in an output light phase difference to a width W of a fifth waveguide section 5 for each length L of the fifth waveguide section 5.

[FIG. 5] A graph showing a change in loss to a width W of a fifth waveguide section 5 for each length L of the fifth waveguide section 5

[FIG. 6] A top view showing a structure of an optical branching element of a second exemplary embodiment of the present invention

[FIG. 7] A top view showing a structure of a digital coherent receiver by a polarized orthogonal multiplex multi value digital signal modulation method which combined two 90 degree optical hybrid interferometers of a third exemplary embodiment of the present invention.

[FIG. 8] A top view showing a structure of an optical branching element disclosed in patent documents 1 and 2

[FIG. 9] A top view showing a structure of a 90 degree optical hybrid function interferometer

### BEST MODE FOR CARRYING OUT THE INVENTION

Next, exemplary embodiments of the present invention will be described with reference to drawings.

### First Exemplary Embodiment

FIG. 1 is a top view showing a structure of an optical waveguide core of an optical branching element of a first exemplary embodiment, and FIG. 2 is a sectional view showing an optical waveguide structure along A-B part of FIG. 1. This optical branching element includes a first waveguide section 3, a fourth waveguide section 4 and a fifth waveguide section 5. The first waveguide section 3 has a shape that the core width is reduced without variation from a first end section to a second end section. The fourth waveguide section 4 has a shape that the core width is increased without variation from a third end section to a fourth end section which connects a second waveguide section 6 and a third waveguide section 7 respectively. The fifth waveguide section 5 has a core width of any value from 0.8 μm to 2.7 μm, and connects the second end section and the third end section. And the relative refractive index difference of a core 1 and a clad 2 of the first to the fifth waveguide sections is set to at least 1.3% with respect to light in a C wavelength domain.

This optical branching element is a Y branch structured-type which outputs light which is incident from the first end section to the second and third waveguide sections 6 and 7, and deals with a light signal of a C band, which is a band of the wavelength from 1530 nm to 1570 nm, suitably. When the relative refractive index difference of the core 1 and the clad 2 is 1.3% or more, appropriate light confinement effect of the optical waveguide is obtained, and the optical branching element can be applied to a miniaturized optical waveguide device using a curved waveguide with the small curvature radius integrally.

When light which propagates meandering is incident from the first end section, the light can be branched so that the light intensity may become sufficiently equal by narrowing the width W of the fifth waveguide and adjusting an electric field strength peak of the propagating light to the center of the waveguide. However, in order to branch the light suppressing even a phase shift, it is necessary to further narrow the width W of the fifth waveguide and to adjust the electric field strength peak of propagating light to the center of the waveguide more strictly.

FIG. 4 shows a calculation result on phase difference with output light 1 and output light 2 with respect to the value W when a Gaussian beam of the wavelength 1550 nm is incident by shifting 1.0 μm from the center of the optical waveguide, using an optical branching element model with the size shown in FIG. 3. Referring to FIG. 4, as W becomes smaller, the output light phase difference converges within a fixed range. A value of W where the output light phase difference converges within fixed limits tends to become larger as the value of the length L of the fifth waveguide section 5 becomes larger. However, when W exceeds 2.7 μm, the output phase difference cannot converge even if L is set no smaller than 700 μm. Accordingly, it is desirable to set W to no more than 2.7 μm.

Although the phase difference of branch output light can be made smaller by narrowing W as mentioned above, when it is made too small, a problem that loss increases occurs. FIG. 5 is a calculation result of a change in loss of the incident light respect to W when a Gaussian beam of the wavelength 1550 nm is incident by shifting 1.0 μm from the center of the optical waveguide, using an optical branching element model with the size shown in FIG. 3. Further, the vertical axis of FIG. 5 is shown as a loss of the output light to the incident light including a fixed coupling loss by shifting 1.0 μm of input. Referring to FIG. 5, the loss increases when W becomes smaller in about 2.7 μm from 4.0 μm. It is considered that this loss is due to radiation from a tapered portion. And when W becomes around 2.7 μm, propagated light is narrowed down to the vicinity of the center of the waveguide, and a value of loss becomes almost fixed. However, when W becomes smaller than 0.8 μm, a value of loss will increase rapidly. This is considered to be the loss which occurs in the fifth waveguide section 5 of the core, and it is desirable to set W to a value larger than 0.8 μm in order to suppress the loss occurrence at this section.

As mentioned above, occurrence of the phase difference and loss of the branched light can be suppressed together when the core width W of the fifth waveguide section 5 is set to between 2.7 μm from 0.8 μm.

As described above, the optical branching element of this exemplary embodiment can branch even light is incident and shifted from the center of the waveguide appropriately suppressing occurrence of the phase difference.

### Second Exemplary Embodiment

Next, a second exemplary embodiment of the present invention will be described. FIG. 6 is a top view showing a structure of an optical branching element of the second exemplary embodiment in which the width of the fifth waveguide section 5 in the optical branching element of the first exemplary embodiment is set to 2 μm. An optical waveguide 8 of 4 μm of width and 4 μm of height is connected with the first end section.

It is desirable to set a tapered angle (inclined angle of the center line of the waveguide and a core edge) of the first waveguide 3 and the fourth waveguide 4 less than 3 degrees so that propagated light does not excite guided mode. Although it is desirable to make the tapered angle further less in order to suppress unnecessary loss of light, the fourth waveguide section 4 in which core width expands can be set the tapered angle greater compared with the first waveguide section 3. Because the size of the whole element becomes so huge that these tapered angles are made little, the tapered angle may be set by taking a chip size and a layout of an optical waveguide into consideration so that required characteristics may be obtained.

In FIG. 6, the length of the first waveguide section 3 is 500 μm, and a core width is narrowed by 2 μm from 4 μm at this part. In this case, the tapered angle is about 0.11 degrees. On the other hand, the length of the fourth waveguide section 4 is 700 μm, and a core width is expanded from 2 μm up to 12.5 μm at this part. In this case, the tapered angle is about 0.43 degrees. A change in a core width of the first waveguide section 3 and the fourth waveguide section 4 together is quasi-static sufficiently, and propagated light does not excite guided mode, and they can suppress a loss by a release of unnecessary higher mode light and deviation of the optical branch characteristics from a design value.

Further, a value of W where a change in the output light phase difference converges within fixed limits tends to become larger as L becomes larger as shown in FIG. 4, and when a change in an output light phase difference is convergent, the variation amount of the phase difference tends to come to fit into the smaller range. However, when L exceeds 700 μm, almost no such tendency is seen any more. Because the loss also increases when L is made long more than necessary, it is desirable to set the length of L to no more than 700 μm.

Incidentally, the optical branching element as shown in FIG. 6 can be produced incorporated with an optical waveguide by applying a fine processing technology used for a general semiconductor manufacturing process. After forming a silicon oxide film of a low refractive index which becomes a lower clad layer on the silicon substrate, for example, by 10 μm of thickness by a chemical vapor growth method, a silicon oxide film of high refractive index which becomes a core layer is laminated by 4 μm of thickness. After that, this core layer is patterned as a waveguide core by a photolithographic method using a photo mask having the patterns of the predetermined waveguide core shape mentioned above. By laminating a silicon oxide film of a low refractive index which becomes an upper clad layer by 10 μm of thickness, and covering on the above-mentioned waveguide core, a predetermined optical waveguide can be structured. A refractive index of a silicon oxide film can be adjusted optionally by the dope amount of the phosphorus and the boron.

In this exemplary embodiment, it is possible to suppress loss of propagating light and improve the efficiency of the optical branch as mentioned above.

### Third Exemplary Embodiment

As a third exemplary embodiment of the present invention, FIG. 7 is a top view showing a structure when applying the present invention to a digital coherent receiver by a polarized orthogonal multiple multi value digital signal modulation method which combined two 90 degrees optical hybrid interferometers as shown in FIG. 9. In FIG. 7, the same optical branching element as one shown in FIG. 6 is used for any of optical branching elements 9-13.

In order to modulate and transmit different data of two polarization conditions of the TE mode and the TM mode, it is necessary to separate these two polarization conditions and to demodulate at a receiving side, in the digital coherent receiver of FIG. 7. In order to perform processing of an output signal by TIA (trans-impedance amplifier) with larger size, according to the position of an input port and an output port, an optical waveguide is pulled around complicatedly in the limited chip size. In a layout of such optical waveguide, because a lot of curve waveguides with the small curvature radius is being used, loss becomes too large in a perfect single mode waveguide. Therefore, it is desirable to use a waveguide which kept the distance until the excited higher-order mode dissolves to some extent. In the case, because the light input especially into optical branching elements 10 and 12 will propagate meandering greatly, in a general Y optical branching element, it is difficult to suppress occurrence of a phase difference to the needed level and perform light branching. In an optical waveguide of such structure, an application of the optical branching element shown in FIG. 6 produces the effect in particular.

The digital coherent receiver of FIG. 7 can be manufactured by the same procedure as the manufacturing method of the optical branching element described by the second exemplary embodiment by applying a fine processing technology used for a general semiconductor manufacturing process.

As mentioned above, this exemplary embodiment can perform light branching with suppressing occurrence of the phase difference to the needed level for even an optical waveguide device in which a waveguide is pulled around complicatedly in the limited chip size and light propagating in the waveguide is meandering greatly.

Although the present invention has been described with reference to the exemplary embodiments above, the present invention is not limited to the above-mentioned exemplary embodiments. Various changes which a person skilled in the art can understand in the scope of the present invention can be performed in the configuration and the details of the present invention.

This application insists on priority based on Japanese Patent Application No. 2010-268548 filed on Dec. 1, 2010 and the disclosure of which is incorporated herein in its entirety by reference.

### DESCRIPTION OF THE REFERENCE NUMERALS

1 core

2 clad

3 first waveguide section

4 fourth waveguide section

5 fifth waveguide section

6 second waveguide section

7 third waveguide section

8 optical waveguide

9-13 optical branching element

21, 22 tapered portion

23 slender part

24, 25 output waveguide

26-29 optical waveguide arm

30, 31 optical branching element

32, 33 coupler

1. An optical branching element comprising:
a first waveguide section which has a shape in which a core width thereof is reduced without variation from a first end section to a second end section;
a fourth waveguide section which has a shape in which a core width thereof is reduced without variation from a third end section to a fourth end section respectively connected to a second and a third waveguide sections; and
a fifth waveguide section which connects the second end section and the third end section and has a core width of any value from 0.8 μm to 2.7 μm, wherein a relative refractive index of the cores and a clad of the first through fifth waveguide section is at least 1.3% with respect to light in a C band wavelength domain.

2. The optical branching element according to claim 1, wherein a length of the fifth waveguide section is shorter than 700 μm.

3. The optical branching element according to claim 1, wherein a tapered angle of the fourth waveguide section is less than 3 degrees and greater than a tapered angle of the first waveguide section.

4. An optical waveguide device using an optical branching element comprising:
first and second optical branching elements that are an optical branching element according to claim 1;
first and second optical waveguide arms which were branched from the first optical branching element and have an equivalent optical path length;
third and fourth optical waveguide arms which were branched from the second optical branching element and have an optical path length difference in π/2 as the degree of phase angle of a propagating light;
a first optical coupler for connecting the first optical waveguide arm and the third optical waveguide arm; and
a second optical coupler for connecting the second optical waveguide arm and the fourth optical waveguide arm.

5. A manufacturing method of an optical branching element comprising:
a step of forming a first cladding layer on a substrate;
a step of laminating a core layer on the first cladding layer;
a step of patterning the core layer and forming a core; and
a step of covering the core with a second cladding layer having a refractive index identical with the first clad, wherein
a relative refractive index difference between a relative refractive index of the core, and that of the first clad and the second clad is set to at least 1.3% with respect to light of a C band wavelength domain, and in patterning the core layer,
a first waveguide section which has a shape that a core width thereof is increased without variation from a first end section to a second end section,
a fourth waveguide section which has a shape in which a core width thereof is increased without variation from a third end section to a fourth end section respectively connected to a second and a third waveguide sections, and
a fifth waveguide section which connects the second end section and the third end section and has a core width of any value from 0.8 μm to 2.7 μm are formed.

6. The manufacturing method of an optical branching element according to claim 5, wherein the narrow waveguide section is made a length thereof shorter than 700 μm.

7. The manufacturing method of an optical branching element according to claim 5, wherein a tapered angle of the fourth tapered waveguide section is less than 3 degrees and is set greater than a tapered angle of the first waveguide section.

8. A manufacturing method of an optical waveguide device using an optical branching element, wherein
a first and a second optical branching elements;
a first and a second optical waveguide arms which were branched from the first optical branching element and have an equivalent optical path length;
a third and a fourth optical waveguide arms which were branched from the second optical branching element and have an optical path length difference in π/2 as the degree of phase angle of a propagating light;
a first optical coupler for connecting the propagating light of the first optical waveguide arm and the third optical waveguide arm; and
a second optical coupler for connecting the propagating light of the second optical waveguide arm and the fourth optical waveguide arm are structured by a manufacturing method of an optical branching element according to claim 5.

9. The optical branching element according to claim 2, wherein a tapered angle of the fourth waveguide section is less than 3 degrees and greater than a tapered angle of the first waveguide section.

10. An optical waveguide device using an optical branching element comprising:
first and second optical branching elements that are an optical branching element according to claim 2;
first and second optical waveguide arms which were branched from the first optical branching element and have an equivalent optical path length;
third and fourth optical waveguide arms which were branched from the second optical branching element and have an optical path length difference in π/2 as the degree of phase angle of a propagating light;
a first optical coupler for connecting the first optical waveguide arm and the third optical waveguide arm; and
a second optical coupler for connecting the second optical waveguide arm and the fourth optical waveguide arm.

11. An optical waveguide device using an optical branching element comprising:
first and second optical branching elements that are an optical branching element according to claim 3;
first and second optical waveguide arms which were branched from the first optical branching element and have an equivalent optical path length;
third and fourth optical waveguide arms which were branched from the second optical branching element and have an optical path length difference in π/2 as the degree of phase angle of a propagating light;
a first optical coupler for connecting the first optical waveguide arm and the third optical waveguide arm; and
a second optical coupler for connecting the second optical waveguide arm and the fourth optical waveguide arm.

12. The manufacturing method of an optical branching element according to claim 6, wherein a tapered angle of the fourth tapered waveguide section is less than 3 degrees and is set greater than a tapered angle of the first waveguide section.

13. A manufacturing method of an optical waveguide device using an optical branching element, wherein
a first and a second optical branching elements;
a first and a second optical waveguide arms which were branched from the first optical branching element and have an equivalent optical path length;
a third and a fourth optical waveguide arms which were branched from the second optical branching element and have an optical path length difference in π/2 as the degree of phase angle of a propagating light;
a first optical coupler for connecting the propagating light of the first optical waveguide arm and the third optical waveguide arm; and
a second optical coupler for connecting the propagating light of the second optical waveguide arm and the fourth optical waveguide arm are structured by a manufacturing method of an optical branching element according to claim 6.

14. A manufacturing method of an optical waveguide device using an optical branching element, wherein
a first and a second optical branching elements;
a first and a second optical waveguide arms which were branched from the first optical branching element and have an equivalent optical path length;
a third and a fourth optical waveguide arms which were branched from the second optical branching element and have an optical path length difference in π/2 as the degree of phase angle of a propagating light;
a first optical coupler for connecting the propagating light of the first optical waveguide arm and the third optical waveguide arm; and
a second optical coupler for connecting the propagating light of the second optical waveguide arm and the fourth optical waveguide arm are structured by a manufacturing method of an optical branching element according to claim 7.

15. An optical waveguide device using an optical branching element comprising:
first and second optical branching elements that are an optical branching element according to claim 9;
first and second optical waveguide arms which were branched from the first optical branching element and have an equivalent optical path length;
third and fourth optical waveguide arms which were branched from the second optical branching element and have an optical path length difference in π/2 as the degree of phase angle of a propagating light;
a first optical coupler for connecting the first optical waveguide arm and the third optical waveguide arm; and
a second optical coupler for connecting the second optical waveguide arm and the fourth optical waveguide arm.

16. A manufacturing method of an optical waveguide device using an optical branching element, wherein
a first and a second optical branching elements;
a first and a second optical waveguide arms which were branched from the first optical branching element and have an equivalent optical path length;
a third and a fourth optical waveguide arms which were branched from the second optical branching element and have an optical path length difference in π/2 as the degree of phase angle of a propagating light;
a first optical coupler for connecting the propagating light of the first optical waveguide arm and the third optical waveguide arm; and
a second optical coupler for connecting the propagating light of the second optical waveguide arm and the fourth optical waveguide arm are structured by a manufacturing method of an optical branching element according to claim 12.
